(19) United States
(12) Patent Application Publication
(10) Pub. No.: US 2026/0156516 A1
(43) Pub. Date: Jun. 4, 2026

(54) COMMUNICATION DEVICE, CONTROL METHOD, AND NON-TRANSITORY COMPUTER READABLE STORAGE MEDIUM

(71) Applicant: CANON KABUSHIKI KAISHA, Tokyo (JP)

(72) Inventor: KOHTARO KOIKE, Kanagawa (JP)

(21) Appl. No.: 19/457,410

(22) Filed: Jan. 23, 2026

Related U.S. Application Data
(63) Continuation of application No. PCT/JP2024/027044, filed on Jul. 29, 2024.

(30) Foreign Application Priority Data
Aug. 7, 2023 (JP) 2023-128669

(51) Int. Cl. H04W 28/02; H04W 72/56; H04W 76/15

(52) U.S. Cl. CPC H04W 28/0236; H04W 72/56; H04W 76/15

(57) ABSTRACT

A communication device that can communicate with another communication device using a plurality of links identifies a characteristic of each of the plurality of links and assigns at least one of the plurality of links to each of at least one type of data to be communicated with the other communication device, based on the characteristic.

### CROSS-REFERENCE TO RELATED APPLICATIONS

This application is a Continuation of International Patent Application No. PCT/JP2024/027044, filed Jul. 29, 2024, which claims the benefit of Japanese Patent Application No. 2023-128669, filed Aug. 7, 2023, both of which are hereby incorporated by reference herein in their entirety.

### BACKGROUND

### Field of the Technology

The present disclosure relates to data communication technology for communication devices that can use a plurality of links in parallel.

### Description of the Related Art

The IEEE 802.11be standard specifies multi-link communication as one of its new functions (see Japanese Patent Laid-Open No. 2021-190722). In multi-link communication, a communication device called a multi-link device (MLD) uses a plurality of links in parallel by linking and coordinating a plurality of communication interfaces. Note that IEEE stands for the Institute of Electrical and Electronics Engineers. Furthermore, the IEEE 802.11be standard is also referred to as Wi-Fi 7 or extremely high throughput (EHT).

### SUMMARY

The present disclosure provides a technology for improving communication efficiency in systems where multi-link communication is performed.

A communication device according to an aspect of the present disclosure includes: a communication unit configured to communicate with another communication device using a plurality of links; an identification unit configured to identify a characteristic of each of the plurality of links; and an assignment unit configured to assign at least one of the plurality of links to each of at least one type of data to be communicated with the other communication device, based on the characteristic.

Features of the present disclosure will become apparent from the following description of embodiments with reference to the attached drawings.

### BRIEF DESCRIPTION OF THE DRAWINGS

FIG. 1 is a diagram showing an example of a configuration of a wireless communication system.

FIG. 2 is a diagram showing an example of a functional configuration of a communication device.

FIG. 3 is a diagram showing an example of association between TIDs and access categories.

FIG. 4 is a diagram showing an example of a hardware configuration of the communication device.

FIG. 5 is a diagram showing an example of a sequence when the communication device establishes multi-link communication with an information communication terminal.

FIG. 6 is a diagram showing an example of a configuration of a TID-To-Link Mapping Element.

FIG. 7 is a diagram showing an example of a flowchart of link assignment to TIDs for image data.

FIG. 8 is a diagram showing an example of a flowchart of link assignment to TIDs for non-image data.

FIG. 9 is a diagram showing an example of a sequence when the communication device establishes multi-link communication with the information communication terminal.

### DESCRIPTION OF THE EMBODIMENTS

### Embodiment 1

### System Configuration

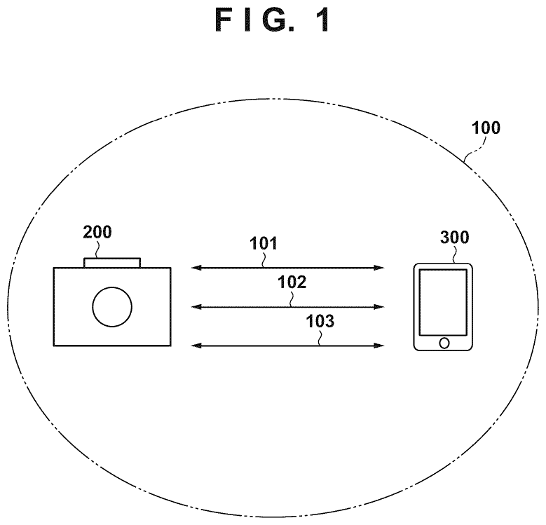

FIG. 1 shows an example of a configuration of a wireless communication system according to the present embodiment. The wireless communication system includes, for example, a communication device 200 and an information communication terminal 300. Each of the communication device 200 and the information communication terminal 300 is a wireless communication device capable of performing wireless communication compliant with the IEEE 802.11 series standards. Note that, in the present embodiment, it is assumed that the communication device 200 operates as an access point (AP), and the information communication terminal 300 operates as a station (STA). Note that IEEE stands for the Institute of Electrical and Electronics Engineers. FIG. 1 shows a state where one AP and one STA exist, but it is also possible that multiple APs and multiple STAs exist. At this time, multiple STAs may connect to one AP, or one STA may connect to multiple APs. The communication device 200 and the information communication terminal 300 may each be any electronic device, such as a smartphone, tablet, PC, video camera, printer, or display. Note that the present embodiment assumes, for example, that the communication device 200 is an image capturing device such as a camera that has both image capturing and communication functions, and the information communication terminal 300 is a smartphone.

The present embodiment assumes that the communication device 200 and the information communication terminal 300 are capable of performing wireless communication compliant with the IEEE 802.11be standard. One of the new functions of the IEEE 802.11be standard is multi-link. In the present embodiment, the communication device 200 and the information communication terminal 300 are configured to be able to perform multi-link communication using a plurality of links within a network 100. The example in FIG. 1 shows that three wireless links (links 101, 102, and 103) are established between the communication device 200 and the information communication terminal 300. Note that the following embodiments describe cases where multi-link communication using the IEEE 802.11be standard is performed, but the present disclosure is not limited thereto. For example, the following discussion can also be applied to multi-link communication compliant with other wireless communication standards or to multi-link communication using a plurality of wired links.

A communication device capable of performing multi-link communication is referred to as a multi-link device (MLD). A communication device that functions to operate as an AP or STA compliant with the IEEE 802.11be standard and operate as an MLD is referred to as an AP MLD or STA MLD, respectively. STA MLD may also be referred to as a non-AP MLD. For AP MLD or STA MLD, the communication interface (I/F) constituting each link may be referred to as an Affiliated AP or Affiliated STA, respectively. An Affiliated STA may also be referred to as an Affiliated non-AP STA.

The links 101, 102, and 103 use frequency bands such as the 2.4 GHz, 5 GHz, and 6 GHz bands, as well as millimeter wave bands (such as 45 GHz band and 60 GHz band), for example. Furthermore, at least some of these links may use frequency bands such as terahertz bands that are higher than millimeter waves. Furthermore, two or more of the established multiple links may use the same frequency band. When the same frequency band is used by two or more links, mutually different channels may be used. In the present embodiment, unless otherwise specified, it is assumed that the links 101, 102, and 103 use the 2.4 GHz band, 5 GHz band, and 6 GHz band, respectively. Furthermore, the links 101 to 103 can use any of the frequency bandwidths of 20 MHz, 40 MHz, 80 MHz, 160 MHz, or 320 MHz that are specified by the IEEE 802.11 series standards. Note, however, that the present disclosure is not limited to this, and at least one of the links 101 to 103 may use a frequency bandwidth such as, for example, 240 MHz or 4 MHz, which is different from those in the above-described examples.

For the multi-link in the IEEE 802.11be standard, a plurality of links are established in parallel. However, there are no specifications regarding which link to assign for transmitting data. Note that the IEEE 802.11be standard specifies that all data can use all links, as the default setting when multi-link is established. On the other hand, if the links use different frequency bands or the like, the link characteristics such as communication speed may also differ from each other. Therefore, it is conceivable that if a link having characteristics unsuitable for a certain type of data is used for transmitting this data, sufficient transmission efficiency may not be achieved. Furthermore, in communication regarding a predetermined service, if a link unsuitable for communication of data with a high priority order is used, the service itself will also fail to achieve sufficient quality.

In the IEEE 802.11 series standards, TIDs are specified as identifiers for classifying data, and a priority order when transmitting frames based on TIDs is defined. Furthermore, the multi-link in the IEEE 802.11be standard specifies the functions to generate a TID-To-Link Mapping, in which TIDs and links are associated with each other, during link establishment and establish a plurality of links. However, there are no specifications how to associate TIDs with links based on the type of data or the characteristics of the links, and thus it is still conceivable that a link unsuitable for a certain type of data may be assigned for transmission of that data.

In light of such problems, the present disclosure provides a technology for utilizing the multi-link more efficiently by assigning links with appropriate characteristics corresponding to the type of data, for frame transmission.

### Device Configuration

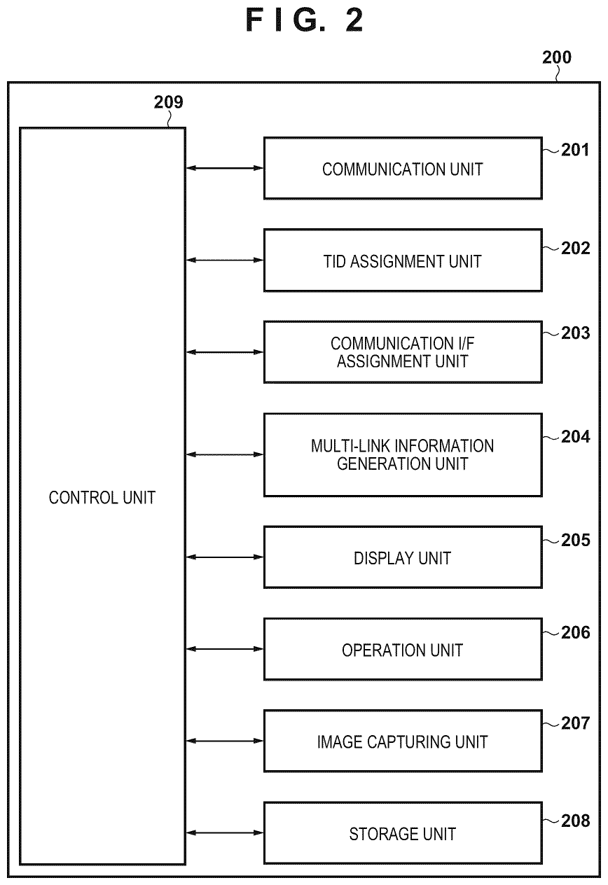

FIG. 2 shows an example of a functional configuration of the communication device 200. The communication device 200 includes, as its functions, a communication unit 201, a TID assignment unit 202, a communication I/F assignment unit 203, a multi-link information generation unit 204, a display unit 205, an operation unit 206, an image capturing unit 207, a storage unit 208, and a control unit 209, for example. Note that the configuration shown in FIG. 2 is merely one example. Some or all of the functional blocks may be replaced with other functional blocks that perform similar functions, and some functional blocks may be omitted or additional functional blocks may be added. Furthermore, a single functional block described below may be divided into a plurality of functional blocks, and a plurality of functional blocks may be integrated into a single functional block.

The communication unit 201 performs communication processing to communicate with another communication device such as the information communication terminal 300. In one example, the communication unit 201 performs wireless communication processing in accordance with the specifications of the IEEE 802.11be standard. The communication unit 201 may also support at least one of the IEEE 802.11a/b/g/n/ac/ax standards (legacy standards), which are standards prior to the IEEE 802.11be standard. Furthermore, the communication unit 201 may support, in addition to the IEEE 802.11 series standards, other communication standards such as Bluetooth (registered trademark), NFC, UWB, ZigBee, and MBOA. Note that NFC stands for Near Field Communication. UWB stands for Ultra Wide Band. MBOA stands for Multi Band OFDM Alliance, where OFDM stands for Orthogonal Frequency Division Multiplexing. UWB includes Wireless USB, Wireless 1394, WiNET, and the like. Furthermore, the communication unit 201 may also support communication standards for wired communication such as wired LAN.

The communication unit 201 may include a plurality of communication I/Fs to allow the communication device 200 to perform multi-link communication. The communication I/Fs may use mutually different frequency bands such as the 2.4 GHz band, 5 GHz band, and 6 GHz band, and some communication I/Fs may use mutually different frequency channels within the same frequency band. The communication unit 201 may perform multi-link communication using a plurality of communication I/Fs that comply only with legacy standards. In the present embodiment, the communication unit 201 includes three communication I/Fs, and the communication I/Fs constitute the respective links 101 to 103 shown in FIG. 1.

The TID assignment unit 202 associates data types with traffic identifiers (TIDs). TID is an identifier for classifying data. The data types include, for example, still image data, moving image data, data (control data) regarding control of the communication device 200, audio data, and the like. The association between data types and TIDs may be designated by an application installed in the communication device 200 or the information communication terminal 300. The TID assignment unit 202 may estimate the data type based on the data volume or input cycle of input data, and associate the estimated data type with TIDs. The association between data types and TIDs may be performed when the communication device establishes multi-link communication with another communication device, or after the communication device has established multi-link communication with another communication device. The TID assignment unit 202 notifies the control unit 209 of the association between data types and TIDs.

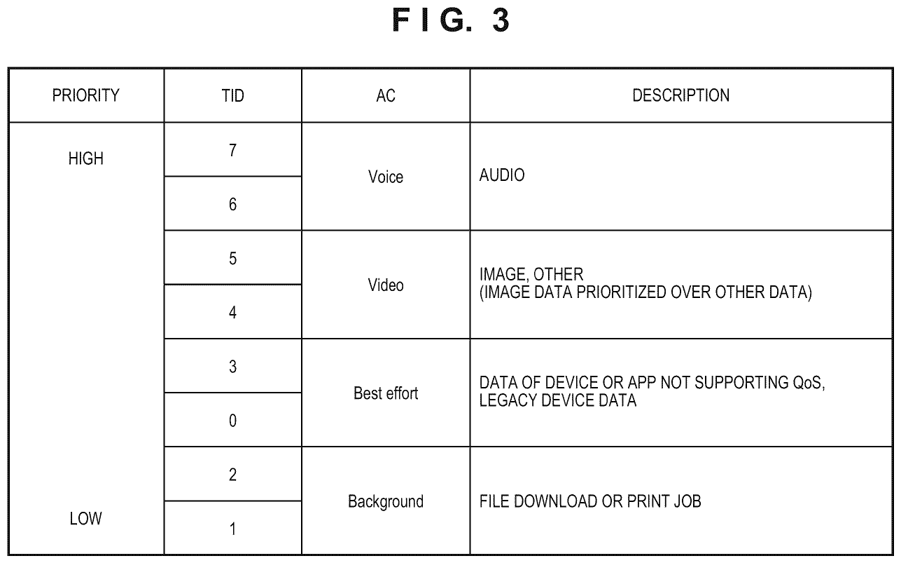

TIDs are given a priority order for transmitting data associated therewith, namely, in descending order of priority, TID7, TID6, TID5, TID4, TID3, TID0, TID2, and TID1. Furthermore, each TID is associated with one of four access categories (ACs) according to its usage. As the ACs, Voice, Video, Best Effort, and Background are defined in descending order of priority. FIG. 3 shows an example of association between TIDs and ACs. TID7 and TID6 are associated with Voice of the ACs, TID5 and TID4 with Video, TID3 and TID0 with Best Effort, and TID2 and TID1 with Background. In the present embodiment, still image data and moving image data recorded by the communication device 200 are associated with either TID5 or TID4, or with Video of the ACs. Moving image data may be associated with TID5, and still image data may be associated with TID4. For example, if pieces of data to be associated are still image data and moving image data generated by the image capturing unit 207 and recorded in the storage unit 208, the pieces of data may be associated with TID4 and TID5, respectively. By associating still image data and moving image data requiring high-speed communication with TIDs that have a high priority order for transmitting the data, it is possible to preferentially assign appropriate links to these TIDs. On the other hand, control data and other data are associated with either TID2 or TID1, or with Background of the ACs. Control data may be associated with TID2, and other data may be associated with TID1. Control data may also be associated with either TID3 or TID0, or with Best Effort of the ACs. For example, if data to be associated is control data for controlling the communication device 200 that is generated by an application installed in the information communication terminal 300, the control data may be associated with any of TID0 to TID3. By associating control data for which the need for high-speed communication is relatively low with a TID that has a low priority order for transmitting the data, it is possible to secure links that enable high-speed communication for still image data and moving image data. In the present embodiment, TIDs associated with still image data and moving image data are referred to as TIDs for image data, while TIDs associated with other data are referred to as TIDs for non-image data. Note that, in the present embodiment, the term “image data” includes both still image data and moving image data, unless otherwise specified. Non-image data includes control data and the like. Note that access categories may be used as identifiers to be associated with data types. Using access categories, which have fewer classifications than TIDs, as identifiers to be associated with data types can simplify processing for associating data types with identifiers and notifications between devices.

The TID assignment unit 202 may also give a different priority order from that shown in FIG. 3 to the identifiers. FIG. 3 shows a priority order for the TIDs and ACs specified by the IEEE 802.11 series standards, but the present disclosure is not limited thereto and another priority order may be used. For example, a table recording a priority order for the identifiers may be stored in the storage unit 208, and the TID assignment unit 202 may read this table to give the priority order to the identifiers.

The communication I/F assignment unit 203 identifies the characteristics of each link configured by a communication I/F and assigns one or more communication I/Fs to identifiers associated with the data type. In the present embodiment, a TID is used as an identifier associated with a data type. The characteristics of each link include the frequency band used by each link, the received signal power from the information communication terminal 300 on each link, the frequency bandwidth usable by each link, the interference power on each link, and the usage rate of each link, as well as the wireless resource usage rate. Link usage rate is the percentage of time for which the link is used for communication per unit time. Wireless resource usage rate is the percentage of wireless resources used for communication, out of all wireless resources available on a link. An example wireless resource is the resource unit specified by the IEEE 802.11ax standard. The communication I/F assignment unit 203 may determine the frequency band and frequency bandwidth used by each link by acquiring them from the storage unit 208. Furthermore, the communication I/F assignment unit 203 may determine the received signal power from the information communication terminal 300 on each link, the interference power, channel usage rate, and the like, by causing the communication unit 201 to measure them. Here, assigning a communication I/F to each TID is equivalent to assigning the link configured by this communication I/F to each TID. For example, when a plurality of links are established using a single communication interface, the communication I/F assignment unit 203 may perform assignment per unit of link rather than assignment per unit of communication I/F, to each TID. In the present embodiment, the processing by which the communication I/F assignment unit 203 assigns a link to each TID is referred to as link assignment. Furthermore, the assignment information indicating the assignment of a plurality of links to respective TIDs generated as a result of link assignment is referred to as TID-To-Link Mapping. TID-To-Link Mapping is represented, for example, as a bitmap indicating whether or not any link is assigned to each TID. For example, if three links exist, three bits per TID are used to indicate which link is assigned to each TID. As an example, it is assumed that the first bit corresponds to the link 101, the second bit corresponds to the link 102, and the third bit corresponds to the link 103. Here, a bitmap representation of “010” for a certain TID indicates that the link 102 is assigned to that TID. When the link 103 is assigned to TID5, “001”, where the bit corresponding to the link 103 is set to 1, while the bits corresponding to the other links are set to 0, is set as the bitmap within the TID-To-Link Mapping corresponding to TID5. When the communication device 200 performs multi-link communication with a plurality of counterpart terminals using the same TID-To-Link Mapping, the communication I/F assignment unit 203 may assign links to TIDs in advance in a fixed manner. Such a fixed TID-To-Link Mapping may be generated before the communication device 200 establishes multi-links with the other communication devices. The communication I/F assignment unit 203 notifies the control unit 209 of the generated TID-To-Link Mapping.

The multi-link information generation unit 204 generates information required for establishing multi-links with another communication device. Examples of the information required for establishing multi-links include network-related information such as ESSID, multi-link communication-related information such as the number of multi-links that can be used in parallel by the MLD, and link-related information such as the frequency band or channel used by each link. These pieces of information may be recorded in the storage unit 208 as communication information. An extended service set identifier (ESSID) is an identifier for uniquely identifying a network, and is used, in this embodiment, to identify the network 100 configured by the communication device 200.

The multi-link information generation unit 204 may generate, using the generated information, an information element that contains information to be given to another communication device for establishing multi-links. Hereinafter, an information element may be referred to as “IE”. Examples of the IEs include the basic multi-link (Basic ML) Element, the reduced neighbor report (RNR) Element, and the SSID Element. For example, the Basic ML Element may contain information such as the number of multi-links that can be used in parallel by the MLD, the address of each Affiliated STA, and the links to be used. The information contained in these Basic ML Elements may be used to determine whether to perform multi-link communication between communication devices. The RNR Element may include information such as the frequency band and channel used by each link. The SSID Element may include the ESSID of the network formed by communication devices. Furthermore, the multi-link information generation unit 204 may generate a TID-To-Link Mapping Element using information such as the TID-To-Link Mapping generated by the communication I/F assignment unit 203.

The display unit 205 performs display of a viewfinder image that allows the user to capture still images or moving images using the communication device 200, which is an image capturing device, display of captured image data, display of characters for interactive operations, and the like. The display unit 205 may provide information to the user by illuminating, flashing, or extinguishing lamps.

The operation unit 206 is used to receive instructions from the user for the communication device 200. The operation unit 206 includes a power button that allows the user to instruct the communication device 200 to start or stop, a release button for instructing the capture of still images or moving images, and a replay button for instructing the replay of captured image data. Also, the operation unit 206 may include operation members such as a connection button that is used when the communication device 200 starts communication with another communication device via the communication unit 201. The operation unit 206 may also include a touch panel configured by the display unit 205.

The image capturing unit 207 generates data for still images and moving images to be transmitted to another communication device by the communication device 200, which is an image capturing device. The image capturing unit 207 is provided with, for example, an optical lens unit, an optical system that controls aperture, zoom, focus, and the like, an imaging element that converts light (video) introduced through the optical lens unit into electrical video signals, and the like. As the imaging element, a complementary metal oxide semiconductor (CMOS) or a charge coupled device (CCD) is typically used. Data generated by the image capturing unit 207 is output to the storage unit 208.

The storage unit 208 stores the control program that is executed by the control unit 209, information for communication, TIDs, Link IDs, and the like. The storage unit 208 may also record associations between data types and TIDs made by the TID assignment unit 202, the TID-To-Link Mapping generated by the communication I/F assignment unit 203, and the like.

The control unit 209 controls the functional units of the communication device 200 according to signals input from the functional units of the communication device 200, control programs stored in the storage unit 208, or the like. For example, the control unit 209 may control the TID assignment unit 202 to associate TIDs with the respective data types. Furthermore, the control unit 209 may control the communication I/F assignment unit 203 to perform link assignment and generate a TID-To-Link Mapping. The control unit 209 may assign one or more links to each data type by associating TIDs with data types and assigning a link to each TID. Furthermore, the control unit 209 may execute control regarding the MLD, such as signal processing for establishing multi-links. Furthermore, the control unit 209 may control the multi-link information generation unit 204 to generate information or information elements required for establishing multi-links with another communication device. Note that multiple pieces of hardware may operate as the control unit 209, by sharing and cooperating in processing for controlling the functional units of the communication device 200.

The information communication terminal 300 is configured similarly to the communication device 200. A communication unit 301, a TID assignment unit 302, and a communication I/F assignment unit 303 of the information communication terminal 300 are similar to the communication unit 201, the TID assignment unit 202, and the communication I/F assignment unit 203 of the communication device 200, respectively. A multi-link information generation unit 304, a display unit 305, an operation unit 306, and an image capturing unit 307 of the information communication terminal 300 are similar to the multi-link information generation unit 204, the display unit 205, the operation unit 206, and the image capturing unit 207 of the communication device 200, respectively. A storage unit 308 and a control unit 309 of the information communication terminal 300 are similar to the storage unit 208 and the control unit 209 of the communication device 200, respectively.

Note that the display unit 305 and the operation unit 306 may be implemented as a single unit such as a touch panel. For example, an application may be activated when the user touches an application icon displayed on the display unit. When such user application operations on the touch panel are given to the communication device 200 as wireless signals, image data saved in the communication device 200 may be downloaded. Also, similarly, the communication device 200 may be controlled by the user's operation.

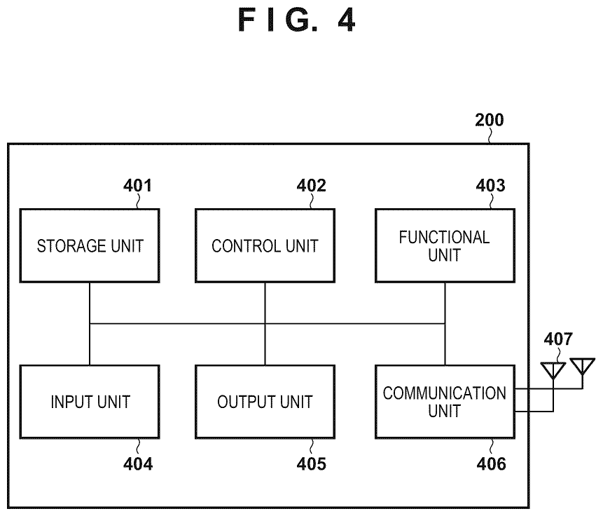

FIG. 4 shows an example of a hardware configuration of the communication device 200. The communication device 200 includes, as an example of its hardware configuration, a storage unit 401, a control unit 402, a functional unit 403, an input unit 404, an output unit 405, a communication unit 406, and an antenna 407. The communication device 200 may have a plurality of antennas. Note that, in the present embodiment, the information communication terminal 300 is assumed to have a hardware configuration similar to that of the communication device 200, and its description is omitted.

The storage unit 401 is configured by one or more memories, including ROM, RAM, and the like, and may store control programs for causing the functional units constituting the communication device 200 to perform various operations, as well as various information such as parameters for communication. ROM and RAM stand for Read-Only Memory and Random Access Memory, respectively. In addition to memory such as ROM and RAM, the storage unit 401 may also include storage media such as floppy disks, hard disks, optical disks, magneto-optical disks, CD-ROMs, CD-Rs, magnetic tapes, non-volatile memory cards, and DVDs.

The control unit 402 is configured by one or more processors, including a CPU, MPU, and the like, and executes the control program stored in the storage unit 401 to control the entire communication device 200. Note that the control unit 402 may control the entire communication device 200 through cooperation between the control program stored in the storage unit 401 and an operating system (OS). Furthermore, the control unit 402 generates signals for establishing multi-links with another communication device, data (wireless frames) for multi-link communication, and the like. Note that CPU and MPU stand for Central Processing Unit and Micro Processing Unit, respectively. If the control unit 402 includes a plurality of processors, which may be implemented using multi-core technology or the like, a configuration is also possible in which the entire communication device 200 is controlled by the plurality of processors.

Furthermore, the control unit 402 controls the functional unit 403 to execute predetermined processing such as communication, image capturing, printing, and projection. The functional unit 403 is hardware that enables the communication device 200 to execute the above-described predetermined processing. For example, if the device is a camera, the functional unit 403 is an image capturing unit and performs image capturing processing. Also, for example, if the device is a printer, the functional unit 403 is a printing unit and performs printing processing. Also, for example, if the device is a projector, the functional unit 403 is a projection unit and performs projection processing.

The input unit 404 receives various operations from the user. The output unit 405 provides various outputs to the user via a monitor screen or speakers. Here, the output provided by the output unit 405 may be display on the monitor screen, audio output via the speakers, vibration output, or the like. Note that the input unit 404 and the output unit 405 may be implemented together as a single module such as a touch panel. Also, the input unit 404 and the output unit 405 may be integrated into the communication device 200, or may each be a separate device from the communication device 200.

The communication unit 406 controls wireless communication compliant with the IEEE 802.11be standard. The communication unit 406 may also control wireless communication compliant with, in addition to the IEEE 802.11be standard, other IEEE 802.11 series standards such as legacy standards. The communication unit 406 controls the antenna 407 to transmit and receive signals for wireless communication generated by the control unit 402. The communication unit 406 is a so-called wireless chip and the communication unit 406 itself may include one or more processors and memories. Note that, if the communication device 200 supports, in addition to the IEEE 802.11be standard, other wireless communication standards such as NFC or Bluetooth standards, or wired communication such as wired LAN, the communication unit 406 may also control communication compliant with these communication standards. Furthermore, if the communication device 200 can perform wireless communication compliant with a plurality of communication standards, the communication device 200 may have a configuration with separate communication units and antennas that correspond to the respective communication standards. The communication device 200 communicates data such as image data, control data, and document data with the information communication terminal 300 via the communication unit 406. Note that the antenna 407 may be configured as a separate unit from the communication unit 406 or may be combined with the communication unit 406 into a single module.

The antenna 407 is an antenna capable of communication in, for example, the 2.4 GHz band, 5 GHz band, 6 GHz band, millimeter wave band, and the like. FIG. 4 shows a configuration where the communication device 200 has two antennas 407. However, the communication device 200 may have one or three or more antennas, and may have one or more antennas for each frequency band usable by the device. Also, when the communication device 200 has a plurality of antennas, the communication device 200 may have a communication unit 406 for each antenna.

### Flow of Multi-Link Establishment

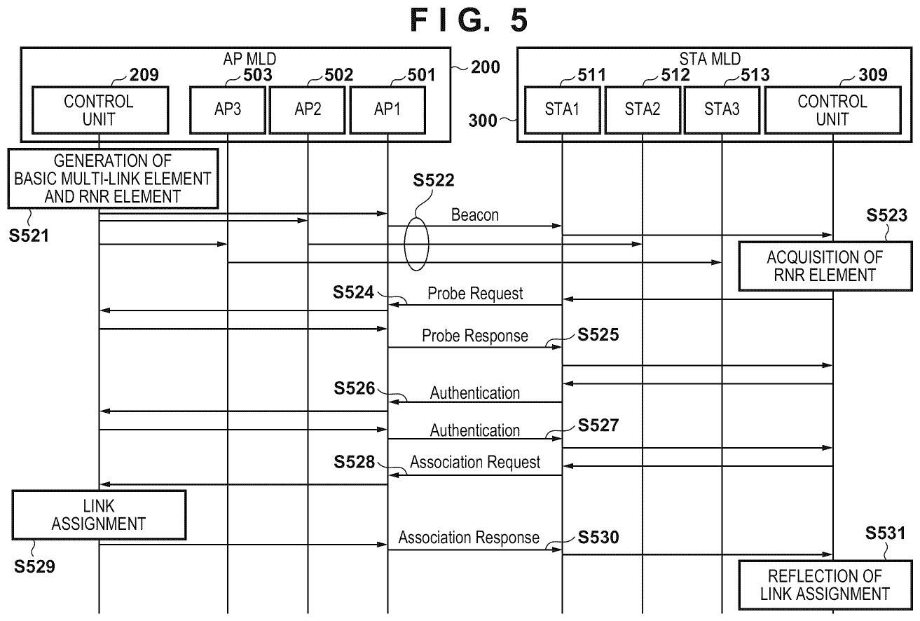

FIG. 5 shows an example of a sequence when the communication device 200 establishes multi-links with the information communication terminal 300. Note that the communication device 200 operates as an AP MLD based on the control program executed by the control unit 209, and the information communication terminal 300 operates as an STA MLD based on the control program executed by the control unit 309. Here, in the communication device 200, the communication unit 201 has three communication I/Fs, as described above. In FIG. 5, these communication I/Fs are shown as an AP 501, an AP 502, and an AP 503, respectively. The AP 501 to AP 503 may be collectively referred to as Affiliated APs, without distinguishing between them. In the information communication terminal 300, the communication unit 301 also has three communication I/Fs. In FIG. 5, these communication I/Fs are shown as an STA 511, an STA 512, and an STA 513, respectively. The STA 511 to STA 513 may be collectively referred to as Affiliated STAs, without distinguishing between them.

The control unit 209 periodically broadcasts a Beacon frame (hereinafter referred to as “Beacon”) using the Affiliated APs. Prior to broadcasting the Beacon, the control unit 209 instructs the multi-link information generation unit 204 to generate a Basic ML Element, an RNR Element, an SSID Element, and the like. The multi-link information generation unit 204 generates a Basic ML Element and the like (S521) and notifies the control unit 209 of the Basic ML Element and the like. The control unit 209 instructs the communication unit 201 to transmit a Beacon containing the Basic ML Element and the like. The communication unit 201 transmits the Beacon using the APs 501 to 503 (S522). In the present embodiment, the subsequent sequence is described assuming that the STA 511 of the information communication terminal 300 has first received the Beacon from the communication device 200.

Upon receiving the Beacon transmitted by the AP 501, the STA 511 notifies the control unit 309 of the Basic ML Element and the like contained in this Beacon. Based on the Basic ML Element and the like, the control unit 309 confirms that the transmission source of the Beacon supports multi-link communication, and acquires information required for establishing multi-links (S523). Additionally, the control unit 309 acquires the ESSID from the SSID Element as the identifier for the network constituted by the communication device 200.

The control unit 309 instructs the STA 511 to transmit a Probe Request frame (hereinafter referred to as Probe Request) containing the SSID Element generated based on the ESSID of the communication device 200. The STA 511 transmits the Probe Request to the AP 501 (S524). Upon receiving the Probe Request, the AP 501 notifies the control unit 209 of the ESSID Element and the like contained in this Probe Request. If the ESSID contained in the ESSID Element matches the ESSID of the control unit 209, the control unit 209 instructs the AP 501 to transmit a Probe Response frame (hereinafter referred to as Probe Response) to the STA 511. The AP 501 transmits the Probe Response to the STA 511 (S525). Upon receiving the Probe Response from the AP 501, the STA 511 notifies the control unit 309 of the Probe Response. Upon receiving the Probe Response, the control unit 309 starts the next step, that is, authentication.

The control unit 309 instructs the STA 511 that has received the Probe Response to transmit an Authentication frame (hereinafter referred to as “Authentication”) to the AP 501. The STA 511 transmits the Authentication to the AP 501 (S526). Upon receiving the Authentication from the STA 511, the AP 501 notifies the control unit 209 of the Authentication. The control unit 209 determines whether or not the authentication is successful based on the received Authentication and instructs the AP 501 to transmit the Authentication containing the determination result to the STA 511. The AP 501 transmits the Authentication to the STA 511 (S527). Upon receiving the Authentication from the AP 501, the STA 511 notifies the control unit 309 of the Authentication. As a result of the Authentication being received by the control unit 309, the authentication is completed. Note that the authentication methods include common key authentication, open authentication, 802.1X authentication, and the like, but the present disclosure is not limited to them. In addition to the authentication determination, the control unit 209 and the control unit 309 may perform processing to mutually confirm that the other device is an MLD.

The control unit 309 instructs the STA 511 to transmit an Association Request frame (hereinafter referred to as Association Request) to the AP 501. Association Request is also referred to as a connection request. Association Request includes a Basic ML Element containing the profile information of each Affiliated STA. The profile information may contain the address of each Affiliated STA and information about the link to be used. The STA 511 transmits the Association Request to the AP 501 (S528). Upon receiving the Association Request from the STA 511, the AP 501 notifies the control unit 209 of the Association Request. The control unit 209 identifies the links to be used for multi-link communication by retrieving the profile information for each Affiliated STA from the received Association Request.

Upon receiving the Association Request, the control unit 209 assigns one or more links for a type of data to be communicated (S529). By performing appropriate assignment between data types and links upon receiving the Association Request, it is possible to flexibly and efficiently use frequency resources based on the link usage status at the time the request occurs. First, the control unit 209 instructs the TID assignment unit 202 to associate still image data, moving image data, and other data with respective TIDs. For example, moving image data is assigned to TID5, still image data to TID4, and other data to TID1. In this case, TID4 and TID5 are TIDs for image data, while TID1 is a TID for non-image data. If there is no data to be communicated when an Association Request is received, association between data types and TIDs may be established after the multi-links are established.

Next, the control unit 209 instructs the communication I/F assignment unit 203 to assign one or more of the links 101 to 103 to each of the TIDs for image data and non-image data. The communication I/F assignment unit 203 assigns one or more of the links 101 to 103 to each of the TIDs for image data and non-image data. For example, the link 103 using the 6 GHz band is assigned to the TID for image data, and the link 101 using the 2.4 GHz band is assigned to the TID for non-image data. The communication I/F assignment unit 203 generates a TID-To-Link Mapping and notifies the control unit 209 of the TID-To-Link Mapping.

The control unit 209 instructs the multi-link information generation unit 204 to generate a TID-To-Link Mapping Element based on the notified TID-To-Link Mapping. The information generation unit 204 generates a TID-To-Link Mapping Element based on the notified TID-To-Link Mapping and notifies the control unit 209 of the TID-To-Link Mapping Element. The control unit 209 instructs the AP 501 to transmit an Association Response (hereinafter referred to as the Association Response) containing the TID-To-Link Mapping Element to the STA 511. The AP 501 transmits the Association Response to the STA 511 (S530). Upon receiving the Association Response, the STA 511 notifies the control unit 309 of the TID-To-Link Mapping Element contained in this Association Response.

Upon acquiring the TID-To-Link Mapping Element, the control unit 309 reflects the TID-To-Link Mapping set by the control unit 209 on the TID-To-Link Mapping in the storage unit 308 (S531). With this, the multi-links between the control unit 209 and the control unit 309 are established, and the assignment between TIDs and links is completed between the control unit 209 and the control unit 309. Subsequently, the control unit 209 and the control unit 309 perform a 4-way handshake to obtain the encryption key, whose detailed description is omitted.

The notification of TID-To-Link Mapping Element may be given via the Beacon or Probe Request. In this case, the AP MLD may generate the TID-To-Link Mapping prior to establishing the multi-links. When multi-link communication with a plurality of counterpart devices is performed using the same TID-To-Link Mapping, individual processing between the communication devices can be omitted by pre-assigning TIDs to links in a fixed manner. Also, the notification of TID-To-Link Mapping may be performed using new wireless frames such as TID-To-Link Mapping Request and TID-To-Link Mapping Response. When no TID-To-Link Mapping was created during the establishment of multi-link communication, the notification of TID-To-Link Mapping is possible using new wireless frames. Furthermore, in a case where a need to change the TID-To-Link Mapping arises due to changes in the communication environment or the like, or other cases, the TID-To-Link Mapping can be updated using new wireless frames.

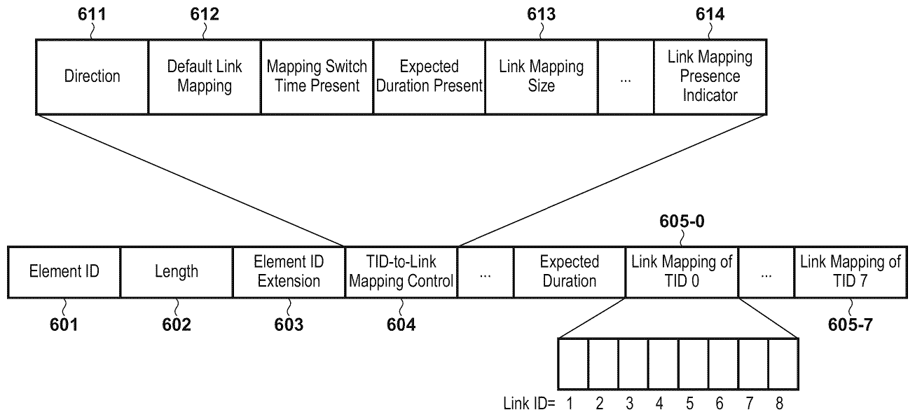

FIG. 6 shows an example of a configuration of a TID-To-Link Mapping Element according to the present embodiment. The TID-To-Link Mapping Element is included in the Association Request and the Association Response. The TID-To-Link Mapping Element may also be included in a Reassociation Request, a Reassociation Response, and the like. Furthermore, the TID-To-Link Mapping Element may be included in the Beacon, Probe Request, Probe Response, Authentication, and the like. The TID-To-Link Mapping Element may be included in new wireless frames such as a TID-To-Link Mapping Request frame, a TID-To-Link Mapping Response frame, and the like. The TID-To-Link Mapping Element does not need to be included in all wireless frames, and a plurality of TID-To-Link Mapping Elements may be included in a single wireless frame. For example, a single wireless frame may include both a TID-To-Link Mapping Element for downlink direction data and a TID-To-Link Mapping Element for uplink direction data. Note that the downlink is the link where data is transmitted from the AP to the STA, and the uplink is the link where data is transmitted from the STA to the AP.

The TID-To-Link Mapping Element contains an Element ID field 601, a Length field 602, and an Element ID Extension field 603. The TID-To-Link Mapping Element may further contain a TID-To-Link Mapping Control field 604 and a Link Mapping Of TID n field 605-n.

The Element ID field 601 and the Element ID Extension field 603 store values indicating that this IE is a TID-To-Link Mapping Element. For example, the values of the Element ID field 601 and Element ID Extension field 603 are set to 255 and 109, respectively. The Length field 602 indicates the total length of this IE.

The TID-To-Link Mapping Control field 604 includes a Direction field 611, a Default Link Mapping field 612, and a Link Mapping Size field 613. The TID-To-Link Mapping Control field 604 further includes a Link Mapping Presence Indicator field 614.

The Direction field 611 indicates the direction of communication to which this IE applies, and the Direction field 611 stores 0 if this IE is applied only to downlink communication, stores 1 if this IE is applied only to uplink communication, and stores 2 if this IE is applied to both. The Default Link Mapping field 612 is a field that indicates whether to set the TID-To-Link Mapping to a default value. If the Default Link Mapping field 612 is 1, the default value is applied to the TID-To-Link Mapping. Here, the default value indicates that all links are assigned to each TID. That is, when the TID-To-Link Mapping has the default value, data associated with each TID can be communicated using all links. On the other hand, if, for example, a certain link cannot be used for some TIDs, the Default Link Mapping field 612 is set to 0. In the present embodiment, since mutually different links are respectively assigned to the TID for image data and the TID for non-image data, the Default Link Mapping field 612 is set to 0.

The Link Mapping Size field 613 indicates the length of the subsequent Link Mapping Of TID n field 605. If the length of the Link Mapping Of TID n field 605 is 1 octet, the Link Mapping Size field 613 is set to 1. If the length of the Link Mapping Of TID n field 605 is 2 octets, the Link Mapping Size field 613 is set to 0.

The Link Mapping Presence Indicator field 614 indicates, using a bitmap, whether or not a field corresponding to each TID exists with respect to the Link Mapping Of TID n field 605-n. For example, if the first bit of the Link Mapping Presence Indicator field 614 is 1, it indicates that the Link Mapping Of TID 0 field 605-0 corresponding to TID 0 exists. In the present embodiment, when TID4 and TID5 are used as TIDs for image data and TID1 is used as a TID for non-image data, the 1st, 4th, and 5th bits corresponding to these TIDs are set to 1. Note that, if the Default Link Mapping field 612 is 1, the Link Mapping Of TID n field 605-n does not exist.

The Link Mapping Of TID n field 605-n represents the TID-To-Link Mapping in a bitmap format. The value of n ranges from 0 to 7, each corresponding to a specific TID. For example, TID4 and TID5, serving as TIDs for image data, correspond to the Link Mapping Of TID 4 field 605-4 and the Link Mapping Of TID 5 field 605-5, respectively. Furthermore, TID1, serving as a TID for non-image data, corresponds to the Link Mapping Of TID 1 field 605-1.

The Link Mapping Of TID n field 605-n is each composed of 8 bits. The position of each bit is associated with the link corresponding to that position. For example, the link 101 has LINK ID=1, and corresponds to the first bit of each Link Mapping Of TID n field 605-n. The link 102 has LINK ID=2, and corresponds to the second bit of each Link Mapping Of TID n field 605-n. The link 103 has LINK ID=3, and corresponds to the third bit of each Link Mapping Of TID n field 605-n. In the present embodiment, since the communication unit 201 forms three links, the fourth bit and subsequent bits of each Link Mapping Of TID n field 605-n are set to 0.

For example, it is assumed that the link 103 using the 6 GHz band is assigned to a TID for image data, and the link 101 using the 2.4 GHz band is assigned to a TID for non-image data. In this case, the third bits of the Link Mapping Of TID 4 field 605-4 and the Link Mapping Of TID 5 field 605-5, each of which corresponds to a TID for image data, will be set to 1. Additionally, the first bit of the Link Mapping Of TID 1 field 605-1, which corresponds to a TID for non-image data, will be set to 1. Upon receiving the TID-To-Link Mapping Element, the information communication terminal 300 can obtain the TID-To-Link Mapping in the communication device 200 via the Link Mapping Of TID n field 605-n.

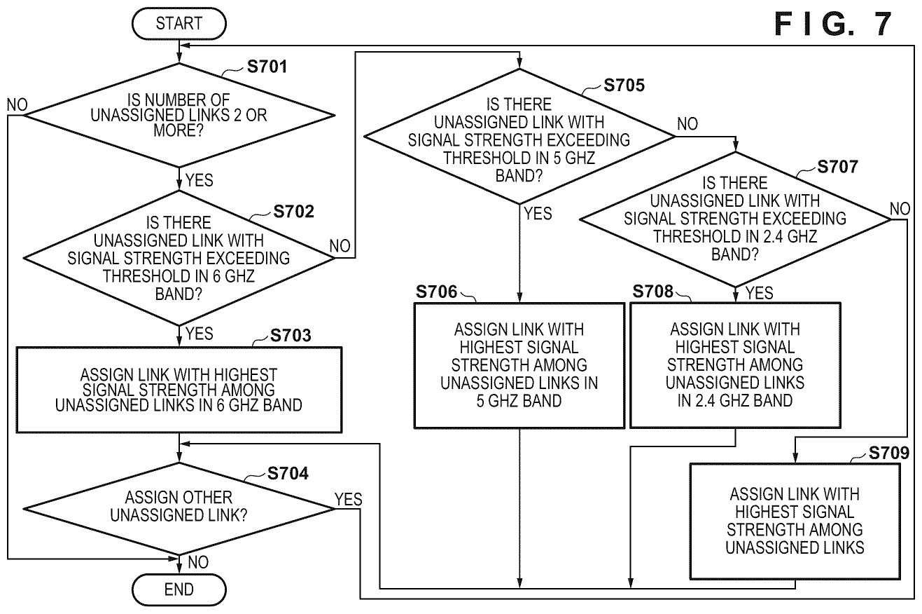

FIG. 7 shows an example of a flowchart of link assignment to a TID for image data according to the present embodiment. The communication device 200 gives each link a priority for communication speed based on the characteristic of the link, and performs link assignment such that links with higher priorities that indicate higher communication speeds are assigned to TIDs with higher transmission priority orders. Note that, in the example of FIG. 7, it is assumed that, based on the frequency band used by each link as the link characteristic, links using higher frequency bands are given higher priorities. This is because higher frequency bands have wider available frequency bandwidths and a larger number of available frequency channels, so it is highly likely that high-speed communication is possible in links using high-frequency bands. Thus, by performing link assignment to identifiers associated with data identifiers taking into consideration link characteristics, it is possible to assign links appropriate for data types.

The communication I/F assignment unit 203 acquires the number of links that are not assigned to any TID (unassigned links) and determines whether or not the number of such links is at least two (S701). The communication I/F assignment unit 203 can calculate the number of unassigned links, for example, by identifying links already assigned to any TID based on the TID-To-Link Mapping recorded in the storage unit 208. Furthermore, the control unit 209 may notify the communication I/F assignment unit 203 of the unassigned links, when requesting the communication I/F assignment unit 203 to perform link assignment.

If the number of unassigned links is at least two (YES in S701), the communication I/F assignment unit 203 determines whether or not any unassigned link using the 6 GHz band has a received signal strength exceeding a threshold (S702). The received signal strength is the strength of the signal received by the communication device 200 from the information communication terminal 300 and may be calculated, for example, using power of the signal received by the communication unit 201. If there is at least one unassigned 6 GHz link whose received signal strength exceeds the threshold (YES in S702), the communication I/F assignment unit 203 assigns the link with the highest received signal strength among them to the TID for image data (S703). This enables, when there are a plurality of unassigned links, assignment of a link capable of faster communication to the TID for image data. Furthermore, if there are a plurality of links whose received signal strengths exceed a predetermined value, any one of those links may be assigned to the TID for image data either randomly or based on predetermined rules. Then, the communication I/F assignment unit 203 determines whether to assign any other unassigned link to the TID for image data (S704). For example, in cases where the amount of image data to be communicated is large, communication of image data is to be conducted within a short period, and the like, assigning a plurality of links to the TID for image data will reduce the required communication time. When assigning a plurality of links to the TID for image data (YES in S704), the processing returns to step S701. If no other unassigned link is assigned (NO in S704), the processing terminates.

If the number of unassigned links is less than two (NO in S701), the communication I/F assignment unit 203 terminates the assignment processing. For example, the communication I/F assignment unit 203 may terminate the assignment processing when multi-link communication is not possible due to the absence of multiple unassigned links, or when a plurality of links cannot be assigned to the TID for image data. Note that when the number of unassigned links is less than two, the communication I/F assignment unit 203 may assign the same link to both the TID for image data and the TID for non-image data.

If there is no unassigned 6 GHz link whose received signal strength exceeds the threshold (NO in S702), the communication I/F assignment unit 203 determines whether or not any unassigned link using the 5 GHz band has a received signal strength exceeding the threshold (S705). If there is at least one unassigned 5 GHz link whose received signal strength exceeds the threshold (YES in S705), the communication I/F assignment unit 203 assigns the link with the highest received signal strength among them to the TID for image data (S706). Furthermore, if there are a plurality of links whose received signal strengths exceed a predetermined value, any one of those links may be assigned to the TID for image data either randomly or based on predetermined rules. Subsequent processing is the same as in step S704.

If there is also no unassigned 5 GHz link whose received signal strength exceeds the threshold (NO in S705), the communication I/F assignment unit 203 determines whether or not any unassigned link using the 2.4 GHz band has a received signal strength exceeding the threshold (S707). If there is at least one unassigned 2.4 GHz link whose received signal strength exceeds the threshold (YES in S707), the communication I/F assignment unit 203 assigns the link with the highest received signal strength among them to the TID for image data (S708). Note that, if there are a plurality of links whose received signal strengths exceed a predetermined value, any one of those links may be assigned to the TID for image data either randomly or based on predetermined rules. Subsequent processing is the same as in step S704.

If there is also no unassigned 2.4 GHz link whose received signal strength exceeds the threshold (NO in S707), the communication I/F assignment unit 203 gives higher priorities to links with larger received signal strengths across all links. In this case, the communication I/F assignment unit 203 assigns the link with the highest received signal strength among all unassigned links to the TID for image data, regardless of the frequency band used by each unassigned link (S709). Note that this is an example, and if there are a plurality of links whose received signal strengths exceed a predetermined value, any one of those links may be assigned to the TID for image data either randomly or based on predetermined rules. Subsequent processing is the same as in step S704. Even when there are no unassigned links by which sufficient received signal strength can be achieved, it is possible to perform link assignment to the TID for image data.

The communication I/F assignment unit 203 may perform link assignment using interference power instead of received signal strength. The communication I/F assignment unit 203 may give higher priorities to links with lower interference powers. Furthermore, the communication I/F assignment unit 203 may assign a link whose interference power is lower than a threshold to each TID. Interference power is the reception strength of an interference signal caused by another communication device using the frequency employed by each link, the proportion of time occupied by such interference signal over a fixed period, or the like. Interference power may be calculated using the power of a signal received by the communication unit 201. Using interference power for link assignment enables link assignment taking into account the period when the link cannot be used due to interference.

The communication I/F assignment unit 203 may also perform link assignment using the frequency bandwidth used by each link, instead of the frequency band used by each link, as the link characteristic. In this case, the wider the frequency bandwidth used by each link, the higher the priority that may be assigned to that link. For example, when the link 101 uses the frequency bandwidth of 20 MHz, the link 102 uses the frequency bandwidth of 80 MHz, and the link 103 uses the frequency bandwidth of 40 MHz, the presence or absence of unassigned links may be determined with respect to the link 102, the link 103, and the link 101, in the stated order. When links use different frequency bandwidths, the link using the wider frequency bandwidth can be assigned to the TID for image data. Note that using a narrower frequency bandwidth can relatively increase the received power strength per unit bandwidth. Therefore, links with narrower bandwidths can achieve more reliable communication. When high-reliability communication is prioritized, higher priorities may be given to links using narrower frequency bandwidths.

The communication I/F assignment unit 203 may determine the priorities to be given to the links, based on the received signal strength from the information communication terminal 300 on each link as the characteristic of the link, regardless of the frequency band used by that link. As an example, higher priorities may be given to links with higher received signal strengths. Furthermore, since higher frequencies result in shorter signal propagation distances, when the distance between devices is large, links using lower frequency bands may achieve higher reception strength, resulting in the higher communication speed, than links using higher frequency bands. Therefore, higher priorities may also be given to links with lower frequency bands. Furthermore, the communication I/F assignment unit 203 may use interference power for each link as a link characteristic. Since links with high interference power may not achieve high communication speeds, higher priorities may also be given to links with lower interference powers.

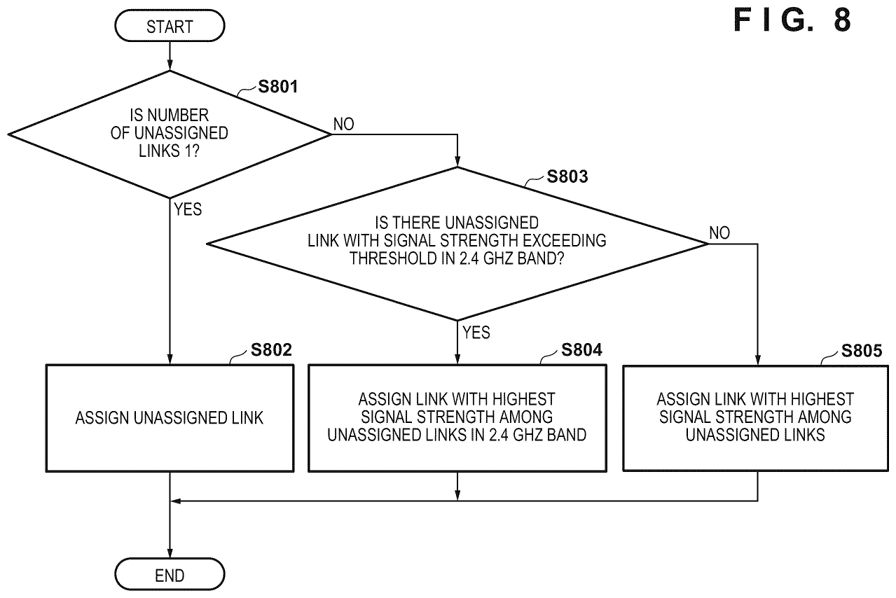

FIG. 8 shows an example of a flowchart of link assignment to a TID for non-image data according to the present embodiment. The communication device 200 gives each link a priority for communication speed, and performs link assignment such that links with lower priorities that indicate lower communication speeds are assigned to TIDs with lower transmission priority orders. In the present embodiment, it is assumed that, based on the frequency band used by each link, links using lower frequency bands are given lower priorities. Note that, in this flowchart, the same processing as in the flowchart of FIG. 7 can be applied, so the description here will be omitted.

The communication I/F assignment unit 203 acquires the number of unassigned links and determines whether or not the number of unassigned links is one (S801). If the number of unassigned links is one (YES in S801), the communication I/F assignment unit 203 assigns this unassigned link to the TID for non-image data (S802) and terminates the processing.

If the number of unassigned links is at least two (NO in S801), the communication I/F assignment unit 203 determines whether or not any unassigned links using the 2.4 GHz band has a received signal strength exceeding a threshold (S803). If there is at least one unassigned 2.4 GHz band link whose received signal strength exceeds the threshold (YES in S803), the communication I/F assignment unit 203 assigns the link with the highest received signal strength among them to the TID for non-image data (S804), and terminates the processing. Note that if there are a plurality of links whose received signal strengths exceed a predetermined value, any one of those links may be assigned to the TID for non-image data either randomly or based on predetermined rules. Subsequent processing is the same as in step S704. For link assignment to the TID for non-image data, unlike link assignment to the TID for image data, the link using the 2.4 GHz band is evaluated first. This is because non-image data has a lower priority than image data and, and due to its smaller data size, there is relatively lower need to use the 5 GHz or 6 GHz band links, which enable high-speed communication. Even when assigning a link to the TID for non-image data before the TID for image data, assigning a link using the 2.4 GHz band to the TID for non-image data allows assignment of a link capable of high-speed communication to the TID for image data afterward.

If there is no unassigned 2.4 GHz link whose received signal strength exceeds the threshold (NO in S803), the communication I/F assignment unit 203 assigns the link with the highest received signal strength among all the unassigned links to the TID for non-image data, regardless of the used frequency band (S805). Note that, if there are a plurality of links whose received signal strengths exceed a predetermined value, any one of those links may be assigned to the TID for non-image data either randomly or based on predetermined rules. Subsequent processing is the same as in step S704. After having performed assignment, the communication I/F assignment unit 203 terminates the processing.

The communication I/F assignment unit 203 may perform link assignment to the TID for non-image data using the frequency bandwidth used by each link, instead of the frequency band used by each link. For example, when the link 101 uses the frequency bandwidth of 20 MHz, the link 102 uses the frequency bandwidth of 80 MHz, and the link 103 uses the frequency bandwidth of 40 MHz, the presence or absence of unassigned links may be determined with respect to the link 101, the link 103, and the link 102, in the stated order. Even when assigning a link to the TID for non-image data before the TID for image data, assigning a link using a narrower frequency bandwidth to the TID for non-image data allows assignment of a link capable of high-speed communication to the TID for image data.

As described above, according to the present embodiment, when establishing multi-link communication between the communication device 200 and the information communication terminal 300, links using frequency bands capable of high-speed communication are assigned to a data type with higher priority. Specifically, the links of the 6 GHz band and 5 GHz band are assigned to image data associated with high-priority TIDs, while the 2.4 GHz band is assigned to control data and other data. This enables the assignment of links with characteristics appropriate for the data type, allowing for more efficient use of the multi-link system.

Note that, in the present embodiment, still image data and moving image data are treated equally as image data. However, still image data and moving image data may be distinguished from each other, and different links may be assigned to each data type. For example, if higher priorities are assigned in order of moving image, still image, and other data, processing may be performed such that TID4 is given to still image data and TID5 is given to moving image data, so that a link using the 6 GHz band is assigned to TID5 and a link using the 5 GHz band is assigned to TID4. This allows mitigation of impacts, such as communication of one of still image data and moving image data disturbing communication of the other data. Furthermore, both the link using the 6 GHz band and the link using the 5 GHz band may be assigned to the TIDs for image data. Assigning more resources to image data can shorten the time period of communication. By assigning a plurality of links to data of a specific type in this manner, high speed communication of data of this type is possible. In these cases, in the Link Mapping Of TID n field 605-n corresponding to each TID, the bits corresponding to Link IDs 2 and 3 will be set to 1.

Furthermore, while the present embodiment has been described using image data, the data type may also be audio data. In this case, as shown in FIG. 3, TID6 or TID7 is associated with audio data, and thus links with higher priorities than image data are assigned. Thus, by assigning TIDs to data to be transmitted and received, it is possible to flexibly control the links assigned for the communication of each data type.

### Embodiment 2

In the present embodiment, the information communication terminal 300 operates as an AP, and the communication device 200 operates as an STA. In Embodiment 1, the communication device 200 operating as an AP performs link assignment to data types, but the present embodiment differs in that the communication device 200, which is an STA, performs link assignment to data types. Therefore, the system configuration, the configuration of each device, the flowchart of link assignment, and the like are the same as those in Embodiment 1, and only the sequence for establishing multi-links between the devices differs.

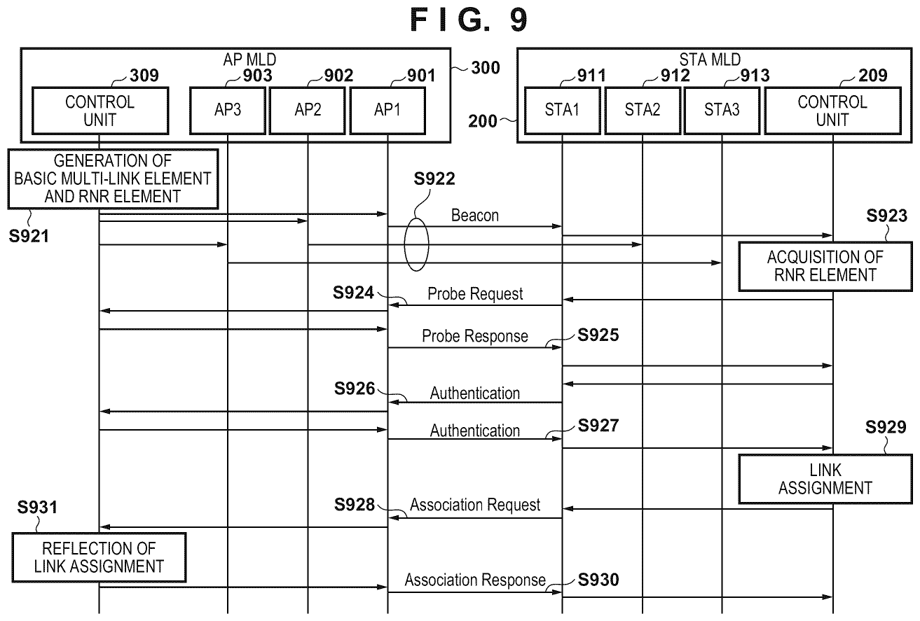

FIG. 9 is an example of a sequence diagram when the communication device 200 establishes multi-link communication with the information communication terminal 300. The communication device 200 operates as an STA MLD, and the information communication terminal 300 operates as an AP MLD. Here, in the communication device 200, the communication unit 201 has three communication I/Fs, and in FIG. 9, these communication I/Fs are shown as an STA 911, an STA 912, and an STA 913, respectively. The STA 911 to STA 913 may be collectively referred to as Affiliated STAs, without distinguishing between them. In the information communication terminal 300, the communication unit 301 also has three communication I/Fs. In FIG. 9, these communication I/Fs are shown as an AP 901, an AP 902, and an AP 903, respectively. The AP 901 to AP 903 may be collectively referred to as Affiliated APs, without distinguishing between them. The processing in S921 to S927 in FIG. 9 is similar to that in S521 to S527 in FIG. 5, and only differs in that the role of the communication device 200 as the AP and the role of the information communication terminal 300 as the STA are reversed. Therefore, the description thereof is omitted.

Upon completion of authentication, the control unit 209 generates a TID-To-Link Mapping (S929), similar to Embodiment 1. Note that, in Embodiment 1, the control unit 209 that operates as an AP generates a TID-To-Link Mapping upon receiving an Association Request. In the present embodiment, the control unit 209 that operates as an STA generates a TID-To-Link Mapping before transmitting an Association Request. The links used for multi-link communication are identified from the Basic ML Element and RNR Element included in the Beacon. The control unit 209 generates a TID-To-Link Mapping Element based on the TID-To-Link Mapping and instructs the STA 911 to transmit an Association Request containing this TID-To-Link Mapping Element to the AP 901. The STA 911 transmits the Association Request containing the TID-To-Link Mapping Element to the AP 901 (S928).

Upon receiving the Association Request, the AP 901 notifies the control unit 309 of the TID-To-Link Mapping Element contained in this Association Request. Upon acquiring the TID-To-Link Mapping Element, the control unit 309 reflects the TID-To-Link Mapping set by the control unit 209 on the TID-To-Link Mapping in the storage unit 308 (S931).

The control unit 309 instructs the AP 901 to transmit an Association Response to the STA 911. The AP 901 transmits the Association Response to the STA 911 (S930). Upon receiving the Association Response, the STA 911 notifies the control unit 209 of the Association Response. Based on a success code and the like contained in the Association Response, the control unit 209 confirms that the TID-To-Link Mapping has been completely reflected by the control unit 309. With this, the multi-link communication between the control unit 209 and the control unit 309 is established, and the assignment between TIDs and links is completed between the control unit 209 and the control unit 309.

According to the present embodiment, even when the communication device 200 operates as an STA MLD and the information communication terminal 300 operates as an AP MLD, links using frequency bands capable of high-speed communication are assigned to a data type with higher priority, similar to Embodiment 1. This enables the assignment of links with characteristics appropriate for the data type, allowing for more efficient use of the multi-links. Also, as a result of link assignment being performed on the STA side, link assignment can be realized taking into account interference or the like that cannot be detected by the AP side.

According to the present disclosure, it is possible to improve communication efficiency in systems where multi-link communication is performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication device comprising:
a communication unit configured to communicate with another communication device using a plurality of links;
an identification unit configured to identify a characteristic of each of the plurality of links; and
an assignment unit configured to assign at least one of the plurality of links to each of at least one type of data to be communicated with the other communication device, based on the characteristic.

2. The communication device according to claim 1,
wherein the assignment unit assigns at least one of the plurality of links to an identifier associated with the type of data.

3. The communication device according to claim 2,
wherein the identifier is a traffic identifier (TID) specified by a IEEE 802.11 series standards.

4. The communication device according to claim 3, further comprising:
an adding unit configured to associate 4 or 5 as the TID in a case where the type of data is still image data or moving image data, and associate any one of 0 to 3 as the TID in a case where the type of data is data regarding control of the other communication device.

5. The communication device according to claim 2,
wherein the identifier is an access category (AC) specified by the IEEE 802.11 series standard.

6. The communication device according to claim 5, further comprising:
an adding unit configured to associate Video as the AC in a case where the type of data is still image data or moving image data, and associate Best Effort or Background as the AC in a case where the type of data is data regarding control of the other communication device.

7. The communication device according to claim 2,
wherein the identifier is given a first priority, which relates to a transmission priority order,
each of the plurality of links is given a second priority, which relates to a communication speed, based on the characteristic, and
the assignment unit assigns a link with a higher second priority, which indicates a higher communication speed, to an identifier with a higher first priority, which indicates a higher transmission priority order.

8. The communication device according to claim 7,
wherein the characteristic is a frequency band used by each of the plurality of links, and
a higher second priority is assigned to a link using a higher frequency band.

9. The communication device according to claim 7,
wherein the characteristic is a received signal strength from the other communication device on each of the plurality of links, and
a higher second priority is assigned to a link having a larger received signal strength from the other communication device.

10. The communication device according to claim 7,
wherein the characteristic is a frequency bandwidth usable by each of the plurality of links, and
a higher second priority is assigned to a link having a wider usable frequency bandwidth.

11. The communication device according to claim 7,
wherein the characteristic is an interference power in each of the plurality of links, and
a higher second priority is assigned to a link having a lower interference power.

12. The communication device according to claim 7,
wherein the assignment unit assigns, among the plurality of links, a link whose received signal strength from the other communication device is larger than a predetermined threshold or a link whose interference power is less than a predetermined threshold, to the identifier based on the second priority.

13. The communication device according to claim 1,
wherein the plurality of links include at least two links that use the same frequency band.

14. The communication device according to claim 1,
wherein each of the plurality of links uses any one frequency band selected from a 2.4 GHz band, a 5 GHz band, a 6 GHz band, and a millimeter wave band.

15. The communication device according to claim 1,
wherein the assignment unit assigns at least one of the plurality of links to the type of data, when establishing the plurality of links with the other communication device.

16. The communication device according to claim 1,
wherein the communication device operates as an access point specified by the IEEE 802.11 series standard.

17. The communication device according to claim 1,
wherein the assignment unit notifies the other communication device of assignment information indicating assignment of the plurality of links, using a Beacon frame, Probe Request frame, Probe Response frame, Association Request frame, Association Response frame, Re-Association Request frame, or Re-Association Response frame specified by the IEEE 802.11 series standard, or using a new frame for notification of the assignment information.

18. The communication device according to claim 1,
wherein the assignment unit performs processing for establishing multi-link communication specified by the IEEE 802.11 series standard.

19. A control method executed by a communication device capable of communicating with another communication device using a plurality of links, comprising:
identifying a characteristic of each of the plurality of links; and
assigning at least one of the plurality of links to each of at least one type of data to be communicated with the other communication device, based on the characteristic.

20. A non-transitory computer readable storage medium that stores a program for causing a computer included in a communication device capable of communicating with another communication device using a plurality of links to perform a method comprising:
identifying a characteristic of each of the plurality of links; and
assigning at least one of the plurality of links to each of at least one type of data to be communicated with the other communication device, based on the characteristic.
